(19) United States
(12) Patent Application Publication
(10) Pub. No.: US 2006/0165106 A1
(43) Pub. Date: Jul. 27, 2006

(54) Contact information management apparatus and method for managing contact information

(76) Inventors: Kenya Nishiki, Chigasaki (JP); Erika Tanaka, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/251,918

(22) Filed: Oct. 18, 2005

(30) Foreign Application Priority Data
Nov. 8, 2004 (JP) 2004-323245

(51) Int. Cl. H04L 12/56; H04L 12/28

(52) U.S. Cl. 370/401

(57) ABSTRACT

To provide a contact information management device that opens contact addresses of community members only to participants of communities. The contact information management device can collect position information from portable terminals provided with position detection means and open contact addresses based on the position information of the portable terminals. A database of contact addresses is created for each of communities.

### CLAIM OF PRIORITY

The present application claims priority from Japanese patent application serial no. 2004-323245, filed on Nov. 8, 2004, the content of which is hereby incorporated by reference into this application.

### BACKGROUND OF THE INVENTION

1. Field of the Invention

The present invention relates to a technology of managing users' contact information, and more particularly to a technology of providing address information for performing communications suitable for user participation communities, locations, and services.

2. Description of the Related Art

Recently, network services have become available for use without constraints of time and places, and an unspecified number of users have come to use the services. On the other hand, even for the same types of services, plural terminals (addresses) are used differently depending on use purposes and places, and the addresses of a party to communicate with must be obtained at the start of communication and selected according to situations of the party. If the addresses are opened to an unspecified number of parties, malicious nuisance calls and spam mail are liable to occur. Therefore, a system is required that enables communication between users through easy search for the addresses of counterparts while securing users' privacy.

To smooth communication, it is conceivable to inquire online of a user whether contact with him/her is currently possible. As a technology for enabling it, a terminal selection method is proposed in JP-A No. 2004-153352 or its counterpart US 2004/0083282 A1. According to the invention described in JP-A No. 2004-153352 or US 2004/0083282 A1, a multimedia communication system includes: two or more terminals capable of multimedia communication; user information storage means that stores information on users who use the terminals; a terminal information storage means that stores information on the terminals; and media information storage means that stores free/busy states of one or more communication media usable in the terminals. In the multimedia communication system, free terminals can be selected at any time by changing users' free/busy states according to users' dynamic situations.

The terminal selection method of the related art aims to improve the usability of a calling party in that connection can be made to free terminals only when a user can use plural terminals at the same time. No selection method is provided for accessing by means desired by receiving users. Moreover, the ability to reject access to contact information depending on calling users is not taken into account.

### SUMMARY OF THE INVENTION

According to the present invention, a technology can be provided for performing safe and smooth communications capable of opening specific addresses to authorized users.

For a user who has plural addresses for the same type of service, an optimum address is selected by determining what communication media the user can use in an area in which he/she is.

For this reason, a contact information management device is provided that opens contact addresses of community members only to participants in the communities. The contact information management device can collect position information from portable terminals provided with position detection means and open contact addresses based on the position information of the portable terminals. A database of contact addresses is created for each of communities.

### BRIEF DESCRIPTION OF THE DRAWINGS

Preferred embodiments of the present invention will now be described in conjunction with the accompanying drawings, in which:

FIG. 1 is a block diagram of a communication system;

FIG. 2 is a functional block diagram of a contact information management device;

FIG. 3 is a block diagram showing hardware configuration of each functional block of a contact information management device;

FIG. 4 is a sequence diagram for explaining a community registration procedure;

FIG. 5 is a drawing showing an operation flow of community participation registration;

FIG. 6 is a table of a community member information database;

FIG. 7 is a table of an address selection policy database;

FIG. 8 is a drawing for explaining qualification information;

FIG. 9 is a sequence diagram showing a contact information inquiry;

FIG. 10 is a drawing showing an operation flow of a position information acquisition unit;

FIG. 11 is a drawing showing an operation flow of a contact information search unit;

FIG. 12 is a drawing showing a flow of session establishment;

FIG. 13 is a drawing for explaining GUI of a communication terminal;

FIG. 14 is a block diagram of a communication system; and

FIG. 15 is a table of registration management of user-owned terminals.

### DETAILED DESCRIPTION OF THE PREFERRED EMBODIMENTS

Preferred embodiments of the present invention will be described in detail with reference to the accompanying drawings. The embodiments below apply to communication services that provide plural contact means according to places such as workplace and home.

### First Embodiment

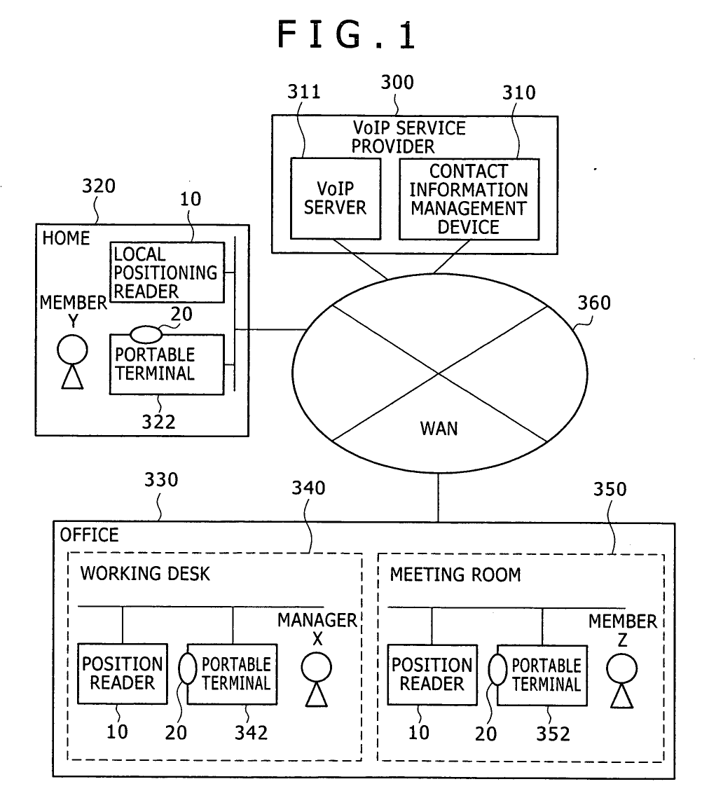

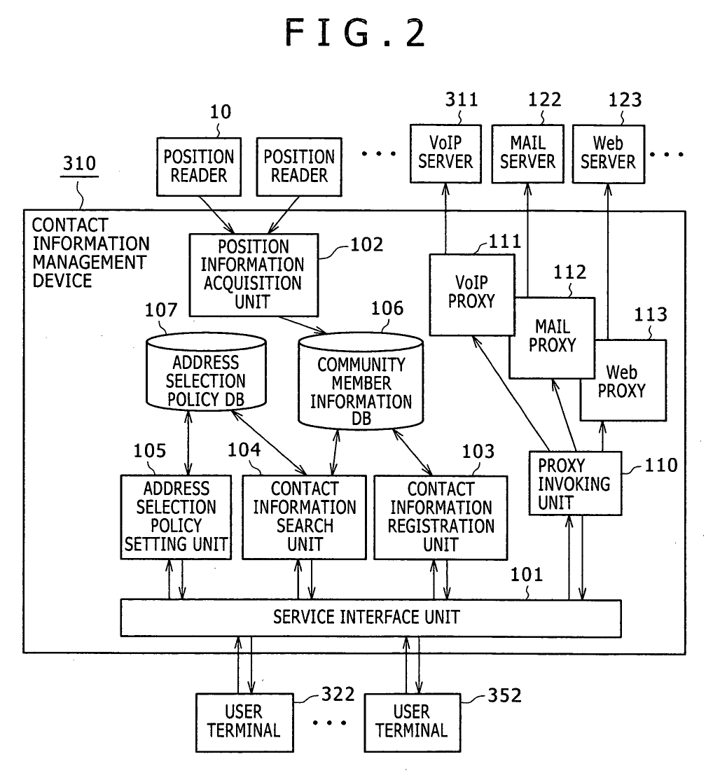

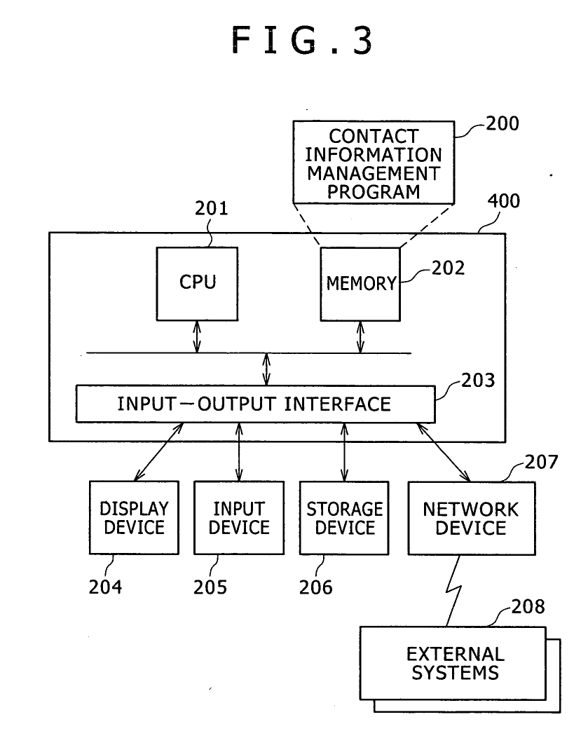

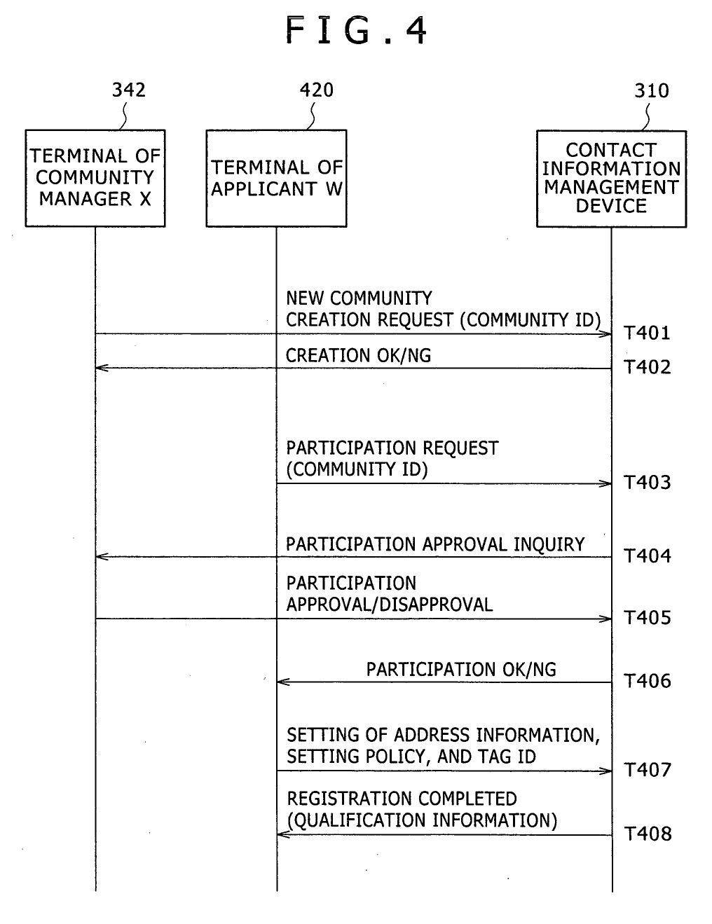

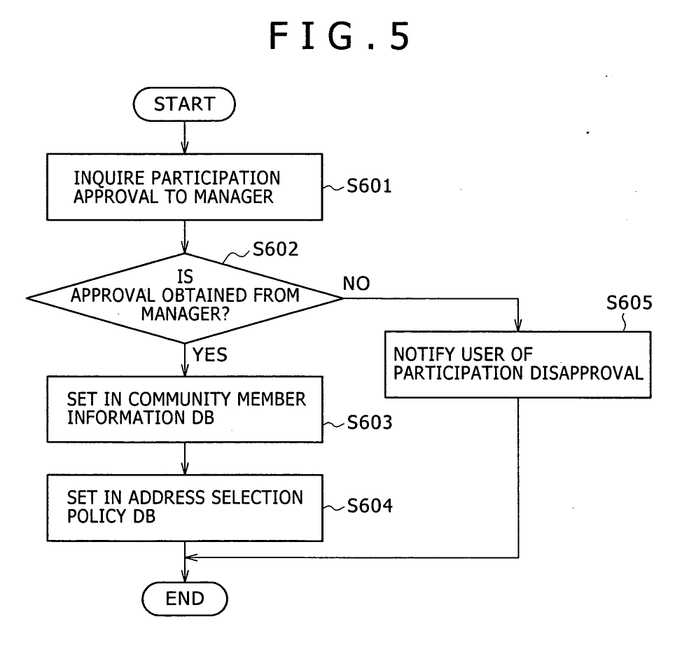

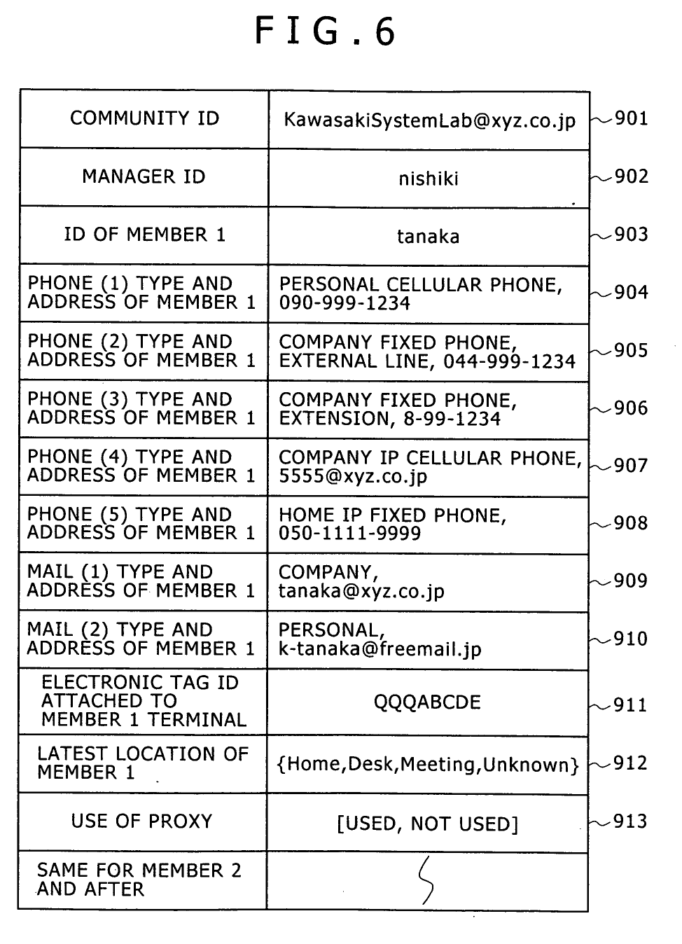

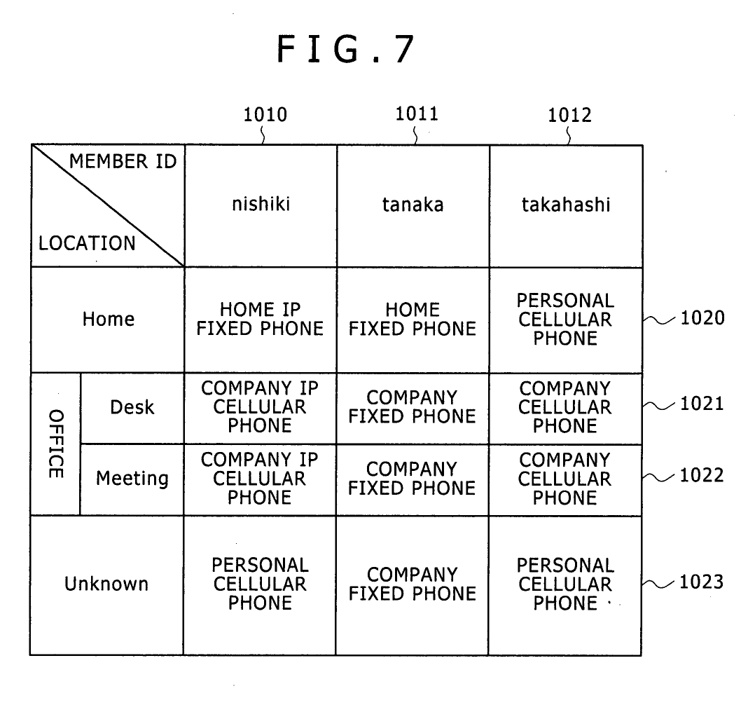

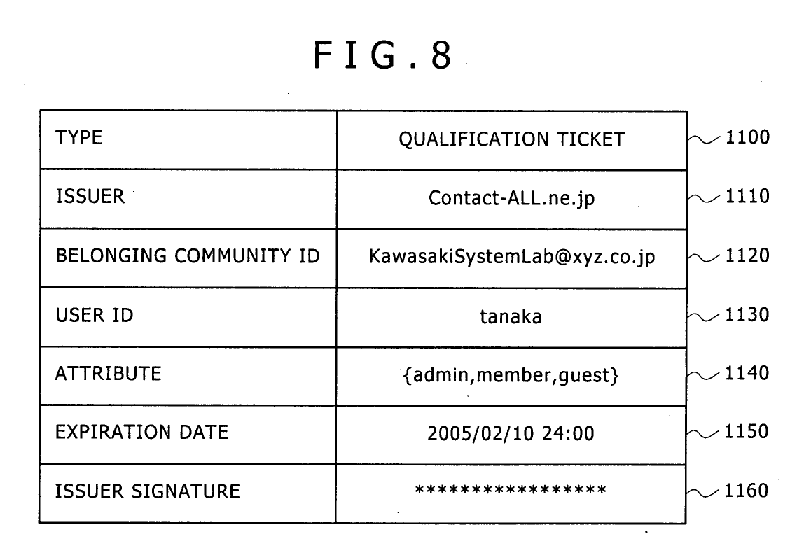

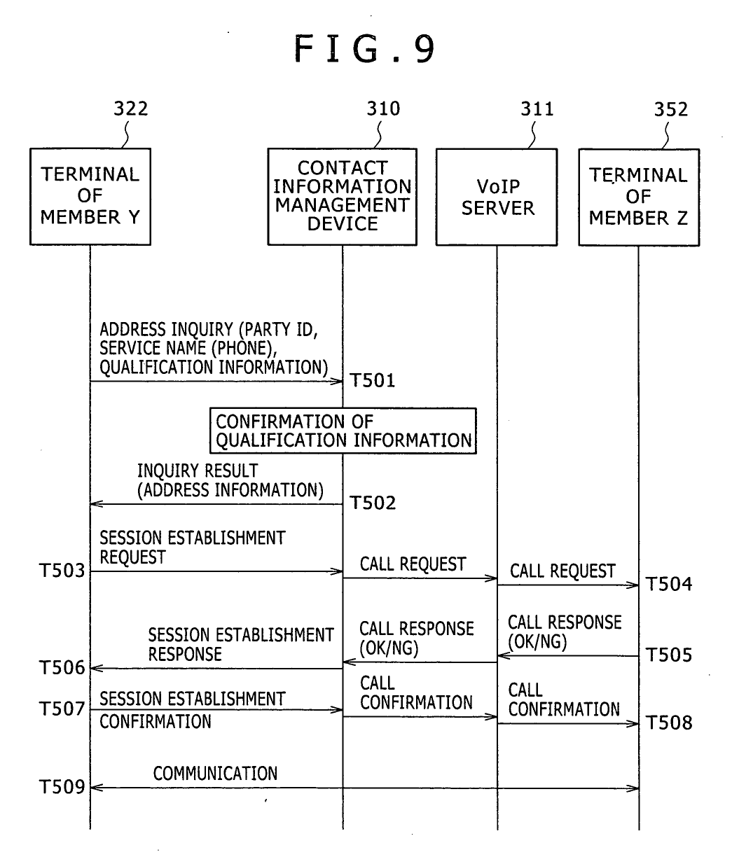

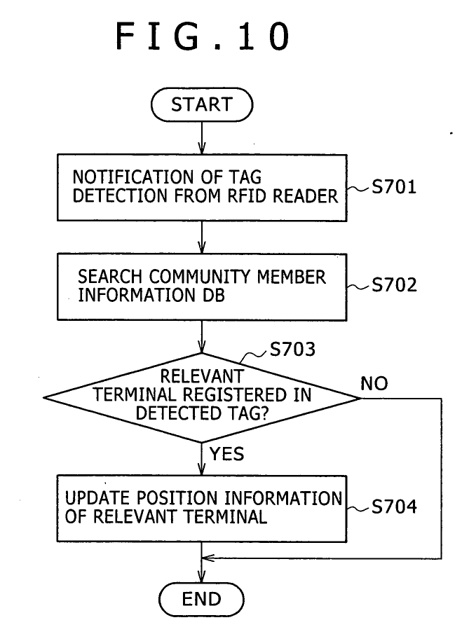

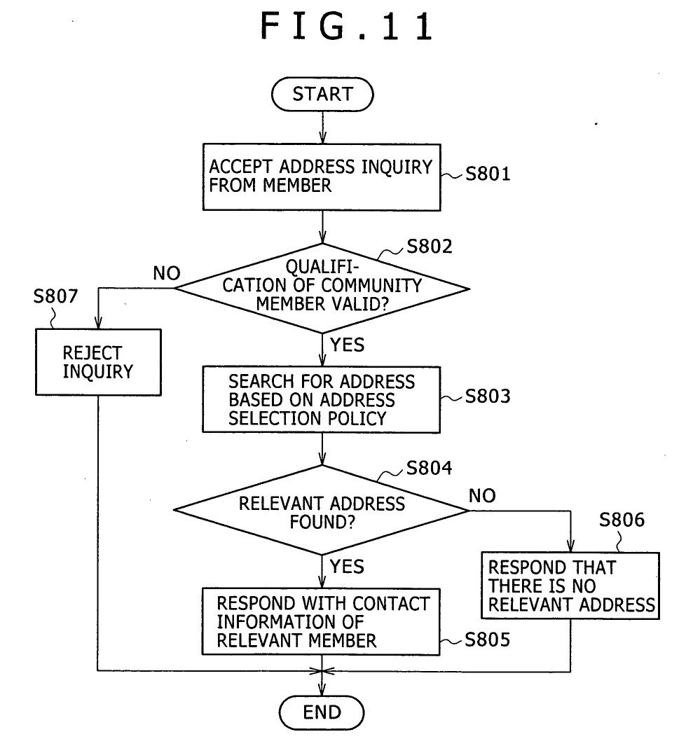

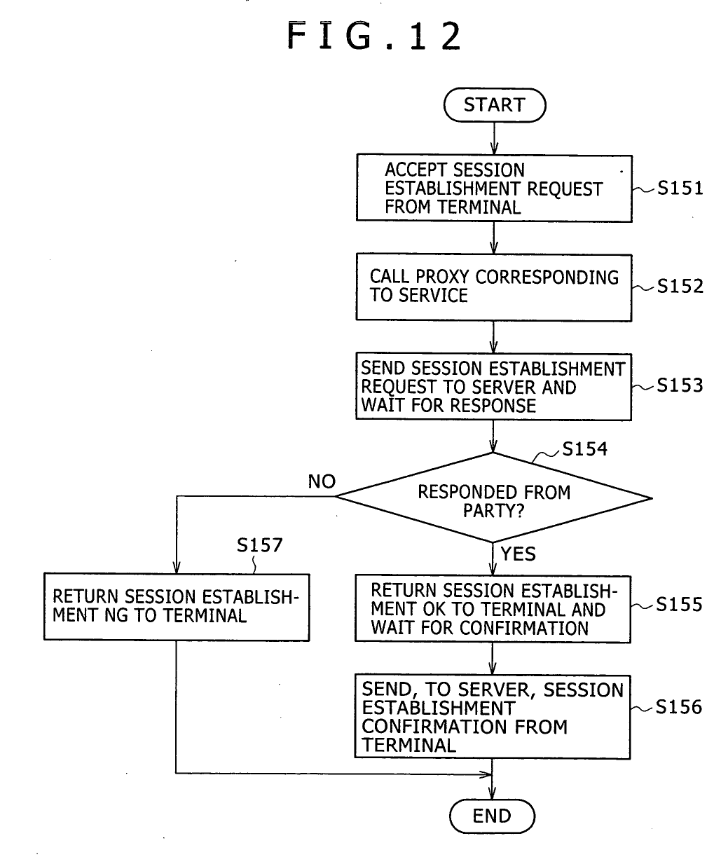

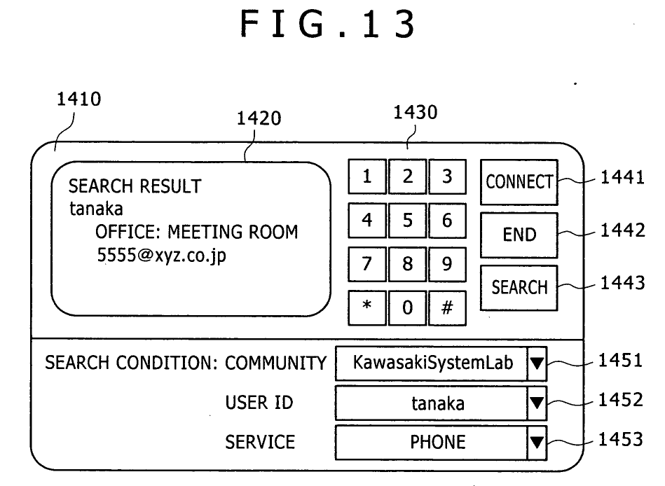

A first embodiment of the present invention is described using FIGS. 1 to 13. FIG. 1 is a block diagram of a communication system. FIG. 2 is a functional block diagram of a contact information management device. FIG. 3 is a block diagram showing hardware configuration of each functional block of the contact information management device. FIG. 4 is a sequence diagram for explaining a community registration procedure. FIG. 5 is a drawing showing an operation flow of community participation registration. FIG. 6 is a table of a community member information database. FIG. 7 is a table of an address selection policy database. FIG. 8 is a drawing for explaining qualification information. FIG. 9 is a sequence diagram showing a contact information inquiry. FIG. 10 is an operation flow drawing of a position information acquisition unit. FIG. 11 is a drawing showing an operation flow of an information search unit. FIG. 12 is a drawing showing an operation flow of session establishment. FIG. 13 is a drawing for explaining screen display of a portable terminal.

Referring back to FIG. 1, a VoIP service provider 300 connects a contact information management device 310 and a VoIP server 311 to a WAN 360, which is the Internet. A community manager X, a community member Y, and a community member Z carry portable terminals 342, 322, and 352 fitted with an RFID (Radio Frequency Identification) tag 20. Use places such as a home 320, a working desk 340 in an office 330, and a meeting room 350 are connected to the WAN 360. In the respective places, local positioning readers 10 are installed to read the RFID tag and transmit the read information to the contact information management device 310. When the RFID tags and the local positioning readers are distant from each other, active RFID tags that receive and transmit radio waves by their own power supply, and RFID tags that use radio waves of a UHF band are used.

The contact information management device 310 is constructed by functional units as shown in FIG. 2. Specifically, it includes: a position information acquisition unit 102 that collects and manages terminal position information from external local positioning readers; a user interface unit 101 that accepts requests from user terminals, distributes processing, and returns processing results; a contact information registration unit 103 that registers contact information such as phone numbers, mail addresses, and URLs of community members; an address selection policy setting unit 105 that sets conditions of selecting community members' address information; a contact information search unit 104 that searches for community members' contact information based on an address selection policy; a proxy invoking unit 110 that calls various servers via proxies; a VoIP proxy 111 that calls a VoIP server 311; a mail proxy 112 that calls a mail server 122; a Web proxy 113 that calls a Web server 123; a community member information database 106; and an address selection policy database 107.

FIG. 3 is a drawing showing a hardware configuration used in this system. The function units of the contact information management device 100 shown in FIG. 2 (user interface unit 101, position information acquisition unit 102, contact information registration unit 103, contact information search unit 104, address selection policy setting unit 105, proxy invoking unit 110, VoIP proxy 111, mail proxy 112, and Web proxy 113) can be built on a computer 400 that includes hardware components such as a CPU 201, a memory 202, an input-output interface 203 and a display device 204, an input device 205, a storage device 206, and a network device 207. In this case, the contact information management program 200 is read into the memory 202 and started as a process during execution. Furthermore, the contact information management device 100 is connected via the network device 207 with the local positioning readers 10, VoIP server 121, mail server 122, and Web server 123, user terminals 322 and 352, and external systems 208 such as the WAN 360.

With reference to the sequence diagram of FIG. 4, the following describes the creation of communities that share contact information, and registration of community members.

A community manager X sends a message indicating a request to create a new community with community ID from the terminal 342 to the contact information management device 310 (T401). When a community of a specified community ID is created, an OK message is returned to the community manager, and when it cannot be created, an NG message is returned (T402). The community manager announces community establishment to community member candidates by means such as mail. When a participation applicant W of a community member candidate sends a community participation request message from his/her terminal 420 to the contact management device 310 (T403), an inquiry message about approval for participation of the user who has issued the participation request is sent to the community manager X (T404). The manager X responds with approval or disapproval for the participation (T405). Upon receipt of the response from the manager X, the contact information management device 310 sends a participation OK message or an NG message to the applicant who has issued the participation request (T406). The applicant who has received the participation OK message sends address information necessary for a contact described later, an address selection policy, and the ID of a tag attached to the terminal to the contact information management device 310 (T407). When the registration of the contact information is complete, qualification information proving a community member is sent to the applicant who issued the participation request (T408). Details of the qualification information are given in FIG. 8. The validity of the qualification information can be checked by adding an electronic signature.

FIG. 5 is a flowchart for explaining the operation of the contact information registration unit 103 and the address selection policy setting unit 105 of the contact information management device 310. For a participation request from a user, an inquiry about approval for the user's participation is issued to a community manager (S601). When participation approval is obtained from the manager (S602), information necessary for contact such as address information, address selection policy, and the ID of a tag attached to the terminal is transmitted from the user, the user's contact information is added to the community member information database 106 (S603), and an address selection condition is set in the address selection policy database 107 (S604). When participation disapproval is returned from the manager, the fact is indicated to the user (S605).

Changes in the information necessary for contact such as the address information, the address selection policy, and the ID of a tag attached to the terminal can be accommodated by offering change approval to the manager in the same procedure as that in FIG. 5.

FIG. 6 shows a table of a community member information database created by the contact information management device. The table contains the following entries: community ID (“KawasakiSystemLab@xyz.co.jp”) 901, manager ID (“nishiki”) 902, ID of member 1 (“tanaka”) 903, usable phone service types and addresses of member 1 (1)=“personal cellular phone, 090-999-1234” 904, (2)=“company fixed phone, external line, 044-999-1234” 905, (3)=“company fixed phone, extension, 8-99-1234” 906, (4)=“company IP cellular phone, 5555@xyz.co.jp” 907, and (5)=“home IP fixed phone, 050-1111-9999” 908, usable mail service types and addresses of member 1 (1)=“company, tanaka@xyz.co.jp” 909 and (2)=“personal, k-tanaka@freemail.jp” 910, electronic tag ID attached to a terminal carried by member 1=“QQQABCDE” 911, latest location of member 1=one of {HOME, Desk, Meeting, Unknown} 912, and use of proxy=one of {used, not used} 913. The above is repeated below by the number of users belonging to the community.

Information indicated by the reference numerals 904 to 911 is information that was transmitted from users, and IP addresses are hidden desirably in terms of security if use of proxy is specified by default.

FIG. 7 shows a table of the address selection policy database 107 created by the contact information management device. The table contains the following entries: columns corresponding to member IDs (“nishiki” 1010, “tanaka” 1011, and “takahashi” 1012), and rows corresponding to locations (“HOME” 1020, “OFFICE-Desk” 1021, “OFFICE-Meeting” 1022, and “Unknown” 1023). Addresses to be selected are set in the table. For example, when a user “nishiki” is at home, “home IP fixed phone” address is selected. Information indicated by the reference numerals 1020 to 1023 is the information that was transmitted from users.

FIG. 8 shows qualification information added to community members by the contact information management device. Specifically, qualification information, which is generated in an XML data format, includes information type (“qualification ticket”) 1100, issuer (“Contact-ALL.ne.jp”) 1110, belonging community ID (“KawasakiSystemLab@xyz.co.jp”) 1120, user ID (“tanaka”) 1130, attribute (one of {admin, member, guest}) 1140, expiration date (“2005/02/10 24:00”) 1150, and issuer signature (“XML signature data”) 1160.

With reference to FIG. 9, the following describes an inquiry about the address and calling of a member to communicate with in a community sharing contact information. The sequence assumes use of proxies.

A member Y sends a message for an address inquiry about a member Z to the contact information management device 310 through the terminal 322 (T501). The inquiry message includes the ID of a party, a service name (phone in this embodiment), and qualification information. The contact information management device 310 checks whether the qualification information of the inquiry message corresponds to the community, and then returns the result of searching for the address to the terminal 322 of the member Y (T502). Furthermore, when starting actual communication, the terminal 322 of the member Y sends a session establishment request message to the contact information management device 310 (T503). The terminal 352 of the member Z is called via the VoIP server 311 (T504). When the terminal 352 of the member Z accepts the calling, a response message is returned to the member Y via the VoIP server 311 and the contact information management device 310 (T505, T506). Furthermore, a session establishment confirmation message is sent from the terminal 322 of the member Y to the terminal 352 of the member Z (T507, T508). As a result, a session is established and communication is started between the terminals (T509).

The above-mentioned embodiment has described communication over phone. For mail, a session is established according to the same procedure by using a mail server to deliver data. The same is also true for Web. In the establishment of the above-mentioned session, when no response is returned for calling by the first address, a call may be tried again by another registered address.

FIG. 10 is a flowchart showing details of the position information acquisition unit 102 in the contact information management device 310. It receives notification of tag detection or non-detection from the local positioning reader 10 (S701). It searches the community member information DB 106 for an entry corresponding to the tag ID (S702). When an entry corresponding to the indicated tag ID exists (S703), position information of the entry is updated (S704).

Position information can be decided by previously preparing a table of correspondences between identifiers (e.g., network addresses) of local positioning readers 10 and installation locations (e.g., a third-floor meeting room of xx building) of the local positioning readers 10. As another method, a relative position of a wireless tag may be determined based on distance data obtained on an identical tag by plural local positioning readers. As still another method, the arrival time of radio waves may be measured instead of field strength to obtain more accurate distance data. As further another method, instead of a wireless tag, a GPS adaptor may be fitted to a terminal to collect latitude and longitude information from an artificial satellite via a local positioning reader. Of course, the information may be delivered directly from a portable terminal. A combination of an RFID tag and a local positioning reader, and the GPS adaptor are position detection means.

With reference to FIG. 11, the following describes in detail the contact information search unit 104. It accepts an address inquiry from a community member (S801). It checks the validity of community members' qualification based on appended qualification information, and if the qualification is valid (S802), searches the community member information DB for the entry of a member to inquire about. Furthermore, it refers to the address selection policy DB based on the current location of an inquiry destination and decides an address to be selected (S803). If a relevant address is found (S804), it returns contact information (address, location, etc.) to the inquiring user (S805). If there is no qualification information or qualification information is invalid, it rejects the inquiry (S807). If the search results in no relevant address being registered, it returns a message indicating that there is no relevant address (S806).

With reference to FIG. 12, the following describes in detail the proxy invoking unit 110. The flow below is on processing assumed to be performed after the address inquiry in FIG. 11. The proxy invoking unit 110 accepts a session establishment request from a calling terminal (S151). Since the service at the address inquiry is a phone, it calls the VoIP proxy 111 (S152). The VoIP proxy 111 sends a session establishment request to the VoIP server 311 (S153). When receiving response from a called terminal (S154), it transmits a session establishment OK to the calling terminal (S155). It receives session establishment confirmation from the calling terminal and transmits session establishment confirmation to the VoIP server (S156). When no response is returned from the called terminal in S154 and a timer has expired, it transmits session establishment NG to the calling terminal (S157). The processing terminates also when, after session establishment OK is transmitted to the calling terminal in S155, no response is returned from the calling terminal and a timer has expired.

When a calling party already knows an address of a called party (when the processing is not performed after the address inquiry), a session establishment request is issued to the server to connect the terminals without passing through the contact information management device.

With reference to FIG. 13, a display screen of a portable terminal is described. A starting screen 1410 includes a message display area 1420, dial keys 1430, command buttons 1441 to 1443, and search condition setting areas 1451 to 1453. When an address is searched for, a community name (“KawasakiSystemLab”), a user ID (“tanaka”), and a service type (“phone”) are set by pull-down selection of the search condition area, and the search button is pressed. A search result is displayed in the message display area in the form of, for example, “tanaka OFFICE: Meeting room 5555@xyz.co.jp.” If the connect button is pressed at this time, a request to connect to the displayed address is sent.

Although GUI software is a phone client in FIG. 13, common contact information management services can be provided for various services by adding a similar search interface to software such as a mail client, a Web browser, and an instant messenger.

According to this embodiment, communications with a communication party having plural addresses (contracts) with respect to services can be made by selecting an appropriate address according to the location of the party.

### Second Embodiment

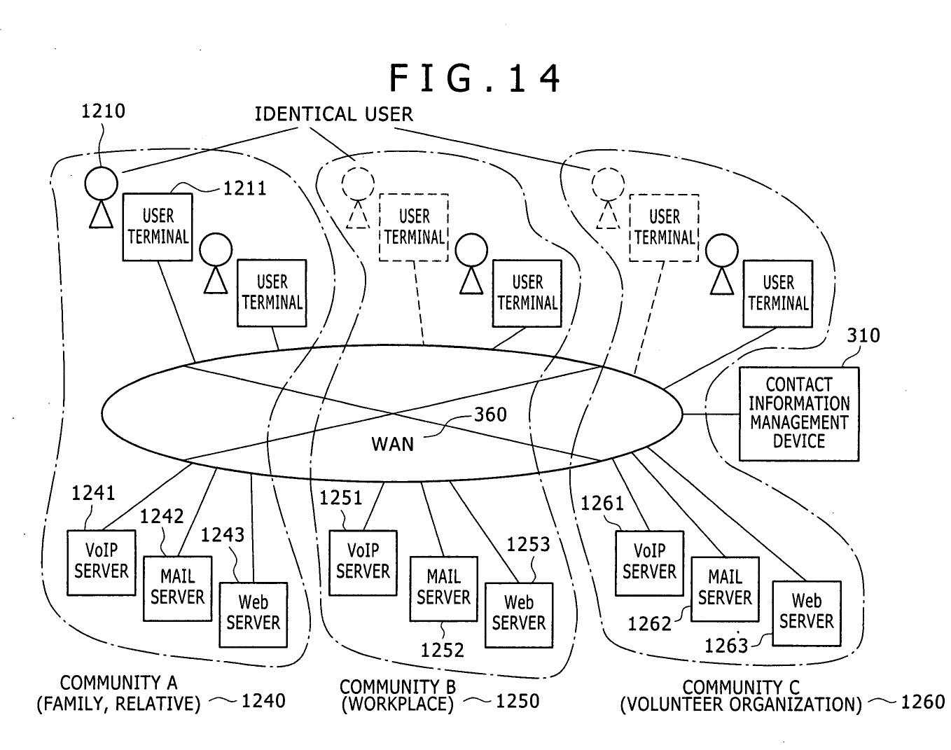

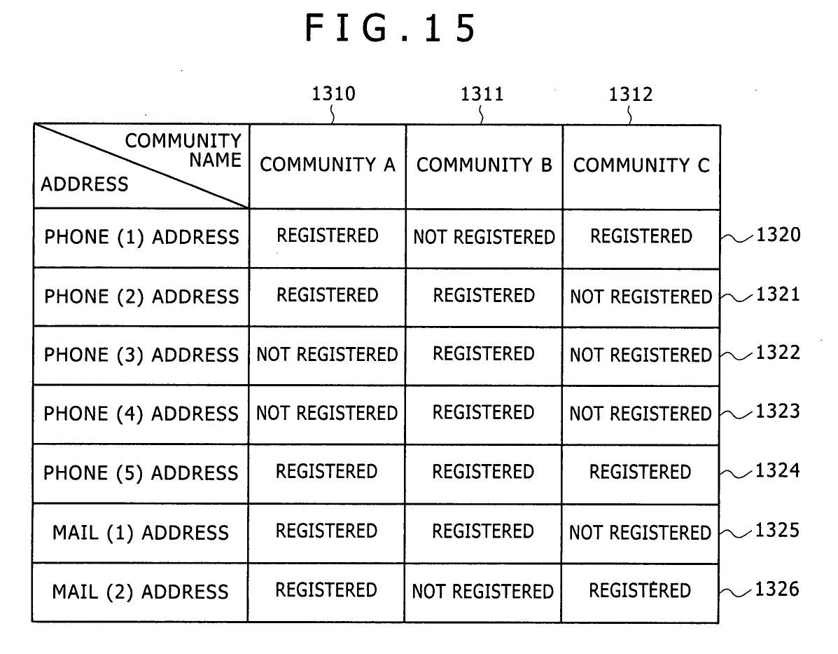

A second embodiment of the present invention will be described with reference to FIGS. 14 and 15. FIG. 14 is a block diagram of a communication system. FIG. 15 is a table of registration management of user-owned terminals.

In FIG. 14, a user 1210 and a terminal 1211 owned by the user belong to plural communities, that is, a community A 1240 composed of a family and relatives, a community B 1250 composed of members in a workplace, and a community C 1260 that performs volunteer activities. The communities respectively operate VoIP servers 1241, 1251, and 1261, mail servers 1242, 1252, and 1262, and Web servers 1243, 1253, and 1263, which can be used via a WAN 360. Furthermore, the contact information management device 310 that can be used in common is connected.

In this embodiment, the hardware configuration and the software configuration of the contact information management device 310 are the same as those in the first embodiment. However, in the first embodiment, the VoIP service provider 300 provides services only for users who receive VoIP services under its management, while in the second embodiment, it provides contact information management services usable also to VoIP service users who are not under its management.

With reference to FIG. 15, the following describes a registration management table that determines whether an address is registered or not for each of communities to which the user 1210 belongs. In the horizontal direction, the table includes “community A” 1310, “community B” 1311, and “community C” 1312, which correspond to community names. In the vertical direction, the table includes phone (1) address to phone (5) address, mail (1) address, and mail (2) address, which correspond to registered addresses. The respective attributes of phone addresses and mail addresses are described in the fields indicted by the reference numerals 904 to 910 in FIG. 6.

In FIG. 15, in a cell in which a row and a column intersect, whether an address is open (registered) or not (not registered) to community members is described. For example, in community A (family and relative), phone (1) address (attribute: personal cellular phone) is open to his/her family and relatives (registered), and phone (4) address (company IP cellular phone) is not open to his/her family and relatives (not registered).

Specifically, in T407 of FIG. 4 of the first embodiment (between S602 and S603 of FIG. 5), address information, address selection policy, and the ID of a tag attached to the terminal which are necessary for contact from the user are transmitted with a not-registered address blanked. As a result, the table of the community member information database of FIG. 6 is blanked in secret portions. Consequently, the user 1210 can set open addresses for each of the communities. His/her location can be concealed by blanking the ID field of the electronic tag so that the latest location information is nullified. As a result, on receiving an address inquiry, the contact information management device 310 displays all the opened addresses.

According to this embodiment, users who belong to plural communities can conceal specific addresses according to types of communities.

According to this embodiment, when a service user has plural addresses, connection to an appropriate address can be made. Since the addresses can be opened only to participants in communities, privacy can be protected, and malicious nuisance calls and spam mail can be prevented. Furthermore, open addresses can be changed for each of communities to which users belong.

What is claimed is:

1. A contact information management device including a community member information database that holds contact addresses of members participating in a community, and a contact information search unit connected to said community member information database,
wherein, on receiving an inquiry about an address of a second member from a first member, said contact information search unit checks qualification information of said first member, searches said community member information database for a contact address of said second member, and transmits said contact address to said first member.

2. A contact information management device including a community member information database that holds contact addresses of members participating in a community, and a contact information search unit connected to said community member information database,
wherein, on receiving an inquiry about an address of a second member from a first member, said contact information search unit checks qualification information of said first member, searches said community member information database for a contact address of said second member, generates contact address information including the located contact address of said second member, and transmits said contact address information to said first member.

3. A contact information management device that holds contact addresses of members participating in a community and responds to an inquiry about said contact addresses from the members, comprising:
a contact information registration unit that stores contact addresses in a community member information database;
an address selection policy setting unit that stores a policy for selecting an address suitable for a situation of a member from a plurality of contact addresses of the member in an address selection policy database; and
a contact information search unit that, when receiving a contact address inquiry from a member, refers to said community member information database and said address selection policy database to generate contact address information to respond with.

4. The contact information management device according to claim 2,
further including a position information acquisition unit that acquires position information from position detection means installed in a member-owned portable terminal, and
generating contact address information based on the position information of said portable terminal acquired by said position information acquisition unit.

5. The contact information management device according to claim 3,
further including a position information acquisition unit that acquires position information from position detection means installed in a member-owned portable terminal, and
generating contact address information based on the position information of said portable terminal acquired by said position information acquisition unit.

6. The contact information management device according to claim 2,
further including a VoIP proxy connected with a VoIP server, a mail proxy connected with a mail server, and a proxy invoking unit that is connected with said VoIP proxy and said mail proxy and calls servers, and
calling the proxies based on said conduct address information.

7. The contact information management device according to claim 3,
further including a VoIP proxy connected with a VoIP server, a mail proxy connected with a mail server, and a proxy invoking unit that is connected with said VoIP proxy and said mail proxy and calls servers, and
calling the proxies based on said conduct address information.

8. A contact information management device including a community member information database that holds contact addresses of members registered in a community,
when receiving a request to participate in said community from a participation applicant, transmitting an inquiry about participation approval to a manager of said community,
when receiving first participation approval from said manager, transmitting second participation approval to said participation applicant,
recording address information of said participation applicant from said participation applicant who received said second participation approval in said communications member information database, and
transmitting qualification information to said participation applicant.

9. A contact information management device that manages contact addresses of a plurality of communities,
including a community member information database and a contact information search unit that performs search of said community member information database, and
holding two types of contact address information about members participating in a plurality of communities, namely first contact address information opened to members of at least a first community, and second contact address information opened to members of a second community.

10. A method of managing contact information of members participating in communities, comprising the steps of:
receiving an inquiry about address information of a second member from a first member;
checking qualification information of said first member;
searching for a contact address of said second member; and
transmitting said contact address to said first member.

11. A method of managing contact information of members participating in communities, comprising the steps of:
receiving an inquiry about address information of a second member from a first member;
checking qualification information of said first member;
searching for a contact address of said second member;
generating contact address information including the located contact address of said second member; and
transmitting said contact address information to said first member.

12. The contact information management method according to claim 11, further comprising the steps of:
receiving a session establishment request of said first member that has received said contact address information;
transmitting a call request to a server;
receiving a response signal from a server that has received a response of said second member; and
transmitting a session establishment response to said first member.
